(19) United States
(12) Patent Application Publication
(10) Pub. No.: US 2015/0221036 A1
(43) Pub. Date: Aug. 6, 2015

(54) Financial Preparedness Tool

(71) Applicant: FMR LLC, Boston, MA (US)

(72) Inventors: Adheesh Sharma, Newton, MA (US); Erin Drakeley, Norwell, MA (US); Suzette Maciel, East Providence, RI (US); John Trainor, Cumberland, RI (US)

(73) Assignee: FMR LLC, Boston, MA (US)

(21) Appl. No.: 14/171,401

(22) Filed: Feb. 3, 2014

(51) Int. Cl. G06Q 40/06

(52) U.S. Cl. CPC G06Q 40/06

(57) ABSTRACT

Methods and systems for retirement planning are provided. A prediction for retirement income is based on financial information of an individual. The prediction includes a confidence level that indicates the level of accuracy of the prediction. The confidence level is based on financial information of the individual.

### FIELD OF THE INVENTION

The invention relates generally to computer-based methods for comprehensive retirement planning. More specifically, the invention relates to comprehensive computer-based retirement planning methods that include a personalized risk assessment (“personalized retirement tool”).

### BACKGROUND

Comprehensive retirement planning can be a complex and challenging process. Comprehensive retirement planning typically focuses on determining projected expenses of retirement based on a multitude of inputs, assumptions and/or scenarios. Comprehensive retirement planning can be done in-person or using an online planning module.

Online comprehensive retirement planning can be more difficult than in-person retirement planning. Online retirement planning tools typically suffer from high user drop out rates due to typical long list of questions which need to be answered for accurate retirement planning. To minimize the number of questions, online retirement tools often use a number of projections regarding spending goals in retirement. The projections and their corresponding implied assumptions, while typically true for an average population, can differ widely for different individuals and/or households. Multiple scenarios can be used to determine multiple projections for a given individual so that a user can consider a variety of scenarios. For example, a retirement plan can be made for a scenario where an individual plans to travel four times per year, while a different retirement plan can be made for a scenario where an individual anticipates having certain medical expenses based on current health conditions.

During retirement planning, a confidence level can be determined for each scenario, based on, for example, market assumptions. The confidence level can describe the probability of the occurrence of a particular scenario for the market assumptions. Some retirement planning tools analyze and/or present a single scenario to a user based on, for example, deterministic rates of return. The rates of return and the scenario chosen typically correspond to a 50% confidence level. Many retirement planning tools analyze retirement plans for multiple scenarios, and present to the user multiple plans, each having a different confidence level. For example, a retirement tool may show a user retirement plans having a 10%. 25% and 65% confidence level. Regardless of whether one or multiple scenarios are chosen, the confidence level selected to present to the user typically does not meaningfully inform the planning outcomes and decisions because the confidence level to be presented is arbitrarily selected.

Therefore, it is desirable to present a user with a computer-based online retirement planning computing tool that allows for presentation of a retirement scenario that has a confidence level that takes into account past financial behavior of the user.

### SUMMARY OF THE INVENTION

Advantages of the claimed invention include computer-based retirement planning that takes into account past financial behavior of the user. A strong correlation can exist between financial prudence and precautionary savings. Many retirement planning accounts for willingness to take risk, and not the ability to take risk. Another advantage of the invention, is accounting for the investor's ability to take risk, regardless of whether the retirement plan adheres to strict fiduciary standards or light suitability standards.

Past financial behavior can be a pragmatic and credible proxy for financial prudence, which in turn can be closely associated with precautionary savings and the flexibility in consumption. Accounting for past financial behavior of the user can result in more accurate and prudent retirement plans.

In one aspect, the invention involves a computerized method of retirement planning. The method involves receiving, by a computing device, financial information for an individual, the financial information including income, contributions to savings over a time duration, and a credit score. The method also involves determining, by the computing device, a savings rate score for the individual, the savings rate score based on the income, contributions to savings made by the individual over one prior year, and a number of years until the individual retires. The method also involves determining, by the computing device, a savings rate direction score for the individual, the savings rate direction score based on the income and contributions to savings made by the individual over a selected prior years. The method also involves determining, by the computing device, a savings history score for the individual, the savings history score based on the time duration. The method also involves determining, by the computing device, a confidence level based on the savings rate score, the savings rate direction score, the savings history score and the credit score. The method also involves determining, by the computing device, a prediction for income needed at retirement for the individual, the prediction having the confidence level.

In some embodiments, the method also involves receiving, by the computing device, health information, lifestyle information, social media information or any combination thereof.

In some embodiments, determining the savings rate score further involves dividing, by the computing device, the contributions to savings made by the individual over twelve prior months by the income and receiving, by the computing device, the savings rate score based on a table look-up that receives as input results of the division.

In some embodiments, determining the savings rate direction score further involves dividing, by the computing device, the contributions to savings made by the individual over a first year of the three prior years by the income to obtain a first savings rate direction sub-score, dividing, by the computing device, the contributions to savings made by the individual over a second year of the three prior years by the income to obtain second savings rate direction sub-score, dividing, by the computing device, the contributions to savings made by the individual over a third year of the three prior years by the income to obtain a third savings rate direction sub-score, determining, by the computing device, whether the difference between the first savings rate direction sub-score, the second savings rate direction sub-score and the third savings rate sub-score indicates an overall increasing, decreasing or neutral savings rate direction for the individual, and receiving, by the computing device, the savings rate direction score based on a table look-up that receives as input the savings rate direction for the individual.

In some embodiments, determining the savings history score for the individual further comprises receiving, by the computing device, the savings history score based on a table look-up that receives as input the time duration.

In some embodiments, determining the confidence level further comprises adding, by the computing device, the savings rate score, the savings rate direction score, the savings history score and the credit score.

In some embodiments, determining the prediction for income needed at retirement for the individual further involves receiving, by the computing device, a first set of information, the first set of information including demographic information, asset information, retirement-goal information, non-retirement goal information, or any combination thereof, performing, by the computing device, Monte Carlo simulation based on the first set of information, and selecting, by the computing device, a result of the Monte Carlo simulation having the confidence level.

In some embodiments, determining the prediction for income needed at retirement for the individual further involves receiving, by the computing device, a second set of information, the second set of information healthcare information, lifestyle information, or any combination thereof, and determining, by the computing device, a planning horizon based on the second set of information, wherein the Monte Carlo simulation is further based on the planning horizon.

In some embodiments, determining the prediction for income further involves receiving, by the computing device, credit information, lifestyle information and healthcare information, determining, by the computing device, essential expenses, the essential expenses based on the credit information, determining, by the computing device, discretionary expenses, the discretionary expenses based on the lifestyle information, determining, by the computing device, healthcare expenses based on the healthcare information, and determining, by the computing device, a rate for income replacement based on the essential expenses, discretionary expenses, healthcare expenses, or any combination thereof.

In some embodiments, the credit information is received from one or more credit reporting bureau. In some embodiments, the lifestyle information is received from one or more social media websites. In some embodiments, the lifestyle information includes places the individual has checked in in from, stores the individual has purchased items from, pages the individual has viewed, social media gifting, or any combination thereof.

In some embodiments, the healthcare information is received from one or more healthcare providers. In some embodiments, the healthcare information includes projected costs for treating health conditions of the individual.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram showing an exemplary computing system for transmitting and/or receiving financial data with a retirement analysis system, according to an illustrative embodiment of the personalized retirement tool.

FIG. 2 is a block diagram showing a system for comprehensive retirement planning, according to an illustrative embodiment of the personalized retirement tool.

FIG. 3 is a flow diagram showing a method for retirement planning, according to an illustrative implementation of the personalized retirement tool.

FIG. 4 is a flow diagram showing a method for determining a savings rate score, according to an illustrative implementation of the personalized retirement tool.

FIG. 5 is a flow diagram showing a method for determining a savings rate direction, according to an illustrative implementation of the personalized retirement tool.

### DETAILED DESCRIPTION

Generally, the personalized retirement tool includes using a computer system to perform online comprehensive retirement plan that includes personalized risk calibration. Financial information, including, income, credit score, and contributions to savings, is received by the computer system for a given individual. A risk calibration module determines an acceptable confidence level for retirement scenarios to present to the individual based on the financial information of the individual. A retirement plan for a scenario that has a confidence level equal to the confidence level specified by the risk calibration module is determined and presented to the individual.

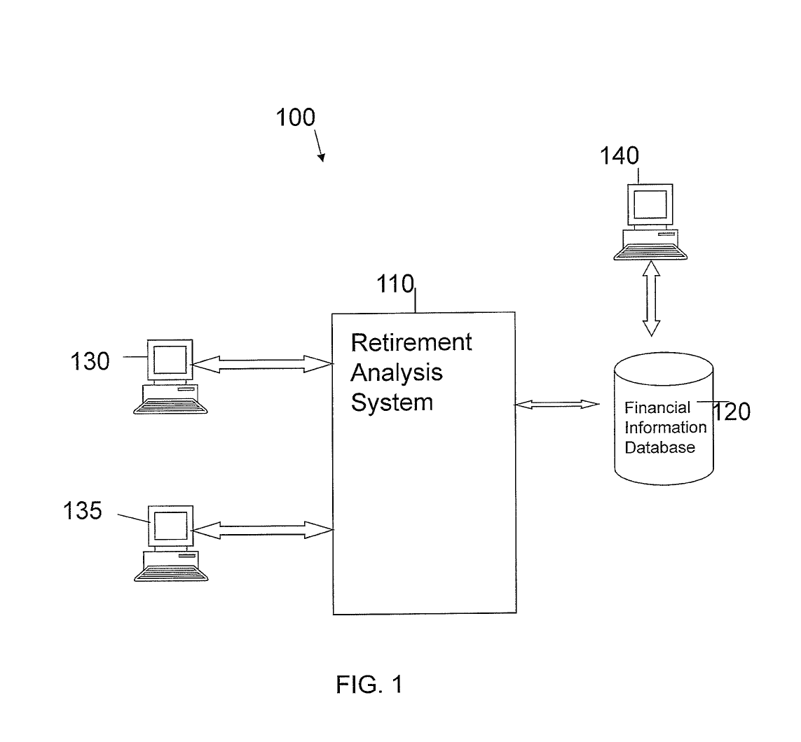

FIG. 1 is a block diagram 100 showing an exemplary computer system for transmitting and/or receiving financial data with a retirement analysis computing system 110, according to an illustrative embodiment of the personalized retirement tool. The components shown here, their connections and relationships, and their functions, are meant to be exemplary only, and are not meant to limit implementations of the personalized retirement tool described and/or claimed in this document.

The retirement analysis system 110 processes analysis of financial information for individuals (e.g. users) to provide a retirement plan. The retirement analysis system 110 is in communication with one or more computing devices 130 and 135, and a financial information database 120. The financial information database 120 is in communication with a computing device 140. Each of the components of the retirement analysis system 110 are interconnected using various busses, and can be mounted on a common motherboard or in other manners as appropriate. The retirement analysis system 110 can process instructions, including but not limited to instructions stored in the retirement analysis system 110, in the financial information database 120 or in the one or more computing devices 130, 135, and 140 to an information display for a GUI on an external input/output device, such as computing devices 130, 135, and 140. In other implementations, multiple processors and/or multiple busses can be used, as appropriate, along with multiple memories and types of memory. Multiple computing devices 130, 135, and 140 can be connected, with each device providing portions of the necessary operations (e.g., as a server bank, a group of blade servers, or a multi-processor system).

Computing devices 130, 135 and 140, retirement planning system 110 and financial services database 120 are intended to represent various forms of digital computers, such as laptops, desktops, workstations, personal digital assistants, servers, blade servers, mainframes, and other appropriate computers.

The retirement analysis system 110 can execute requests for retirement plans. Requests to perform retirement planning can be input through computing devices 130 and 135. The requests to perform retirement planning can include information needed to perform the retirement analysis. The retirement analysis system 110 performs the retirement analysis based on the information included in the request, information retrieved from the financial information database 120, information retrieved/received from social media sources, credit bureau sources (with authorization from the individual), or any combination thereof.

The financial information database 120 stores information used to plan retirement. The information used to plan retirement can include income, credit scores, credit history, health history information, lifestyle information, household information, asset information, savings contributions, contributions to retirement plans, non-retirement goals, or any combination thereof. The financial information database 120 can receive the financial data from other financial planning applications, financial institutions, the individual, social media websites, doctor offices, hospitals, financial institutions, or any combination thereof.

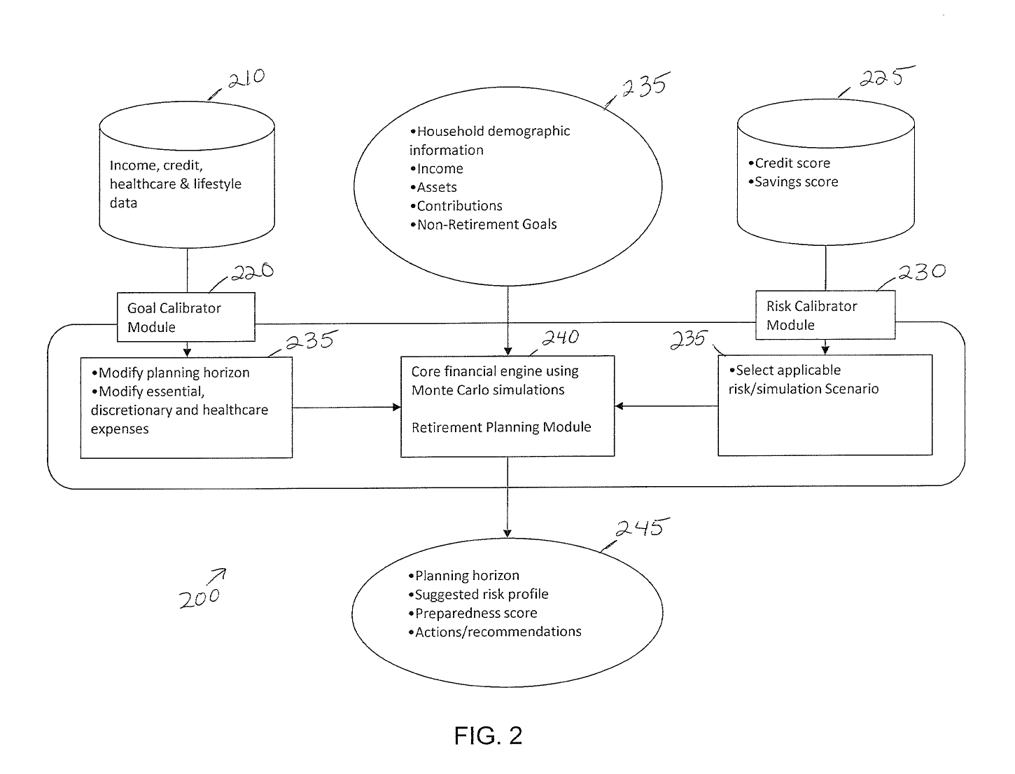

FIG. 2 is a block diagram showing a system 200 for comprehensive retirement planning, according to an illustrative embodiment of the personalized retirement tool. The system 200 includes goal calibration inputs 210, goal calibration module 220, risk calibration inputs 225, a risk calibration module 230, retirement simulation inputs 235, a retirement simulation module 240 and retirement simulation output 245. The goal calibration inputs 210, risk calibration inputs 225, and/or the retirement simulation inputs 235 can be input by a user, received from a database, and/or received from the internet. It is apparent to one of ordinary skill that the goal calibration inputs 210, risk calibration inputs 225, and/or the retirement simulation inputs 235 are exemplary in nature and that additional inputs relevant to retirement planning can be used.

i. Goal Calibration Module

The goal calibration module 220 estimates an amount of yearly retirement spending for an individual based on income, lifestyle and/or healthcare information of the individual. In some embodiments, the amount of retirement spending for an individual is also based on the individual's credit. Table 1 shown below is an example of credit, lifestyle, and health information for an exemplary individual.

TABLE 1

| Average Credit Score | | |
|---|---|---|
| (e.g., from 3 Bureaus) | Lifestyle | Health |
| 760 | Very Active | Good |

In some embodiments, the goal calibration module 220 determines the amount of retirement spending as follows:

Retirement spending=Iₑₛₜ_{_{—}}ᵣₑₜ×Rᵣₐₜₑ EQN. 1

where Iₑₛₜ_{_{—}}ᵣₑₜ is an estimate for income at the time of retirement and Rᵣₐₜₑ is a retirement income replacement rate.

In some embodiments, the estimate for income at the time of retirement (lₑₛₜ rₑₜ) is determined as follows:

Iₑₛₜ_{_{—}}ᵣₑₜ=I_{curr}×(1+WGᵣₐₜₑ)̂(N_{years}) EQN. 2

Where I_{curr} is the current income, WGᵣₐₜₑ is the real wage growth rate assumption (e.g., 1.5%), and N_{years} is the number of years before pre-retirement. For example, if a 25 year old retires at age 67, pre-retirement age is 66 and N_{years} is 66−25=41.

In some embodiments, the retirement income replacement rate (Rᵣₐₜₑ) is determines as follows:

Rᵣₐₜₑ=Bᵣₐₜₑ×Cᵣₐₜₑ EQN. 3

where Bᵣₐₜₑ is a base replacement rate and Cᵣₐₜₑ is an expense calibration rate. In some embodiments, Cᵣₐₜₑ is input by a user. In some embodiments, Cᵣₐₜₑ is based on an extrapolation of income based on spending patterns over a predefined duration. In some embodiments, the predefined duration is the previous year.

The goal calibration module 220 can determine the base replacement rate (Bᵣₐₜₑ) based on the estimated amount of income at the time of retirement Iₑₛₜ_{_{—}}ᵣₑₜ. In some embodiments, the base replacement rate is 85%. In some embodiments, the base replacement rate is determined based on amount of retirement savings needed, overall savings, spending associated with later working/accumulation years, college savings, mortgage payments, tax rates (e.g., reduction due to absence of payroll taxation of social security benefits), reduction in core expenses (e.g., housing, food, and/or transportation). In some embodiments, the base replacement rate is determined by any method known in the art.

In some embodiments, the base replacement rate is determined from a look up table. In particular, the estimate for income at the time of retirement (Iₑₛₜ_{_{—}}ᵣₑₜ) can be an input to a table that returns a corresponding base replacement rate. For example, Table 2 shows base replacement rates for various ranges of estimates for income at the time of retirement (Iₑₛₜ_{_{—}}ᵣₑₜ).

TABLE 2

| | | | Replacement Rate |
|---|---|---|---|
| | | | (CalibrationRatio × |
| Lower | Upper | CalibrationRatio | 85%) |
| $— | $9,999 | 1.12 | 95.0% |
| $10,000 | $19,999 | 1.12 | 95.0% |
| $20,000 | $29,999 | 1.12 | 95.0% |
| $30,000 | $39,999 | 1.12 | 95.0% |
| $40,000 | $49,999 | 1.12 | 95.0% |
| $50,000 | $59,999 | 1.09 | 93.0% |
| $60,000 | $69,999 | 1.06 | 90.0% |
| $70,000 | $79,999 | 1.00 | 85.0% |
| $80,000 | $89,999 | 0.98 | 83.0% |
| $90,000 | $99,999 | 0.96 | 82.0% |
| $100,000 | $109,999 | 0.95 | 81.0% |
| $110,000 | $119,999 | 0.93 | 79.0% |
| $120,000 | $129,999 | 0.91 | 77.0% |
| $130,000 | $139,999 | 0.89 | 76.0% |
| $140,000 | $149,999 | 0.88 | 74.7% |
| $150,000 | $159,999 | 0.86 | 73.5% |
| $160,000 | $169,999 | 0.85 | 72.2% |
| $170,000 | $179,999 | 0.83 | 70.9% |
| $180,000 | $189,999 | 0.82 | 69.6% |
| $190,000 | $199,999 | 0.80 | 68.4% |
| $200,000 | $209,999 | 0.79 | 67.1% |
| $210,000 | $219,999 | 0.77 | 65.8% |
| $220,000 | $229,999 | 0.76 | 64.5% |
| $230,000 | $239,999 | 0.74 | 63.3% |
| $240,000 | $249,999 | 0.73 | 62.0% |
| $250,000 | $100,000,000 | 0.73 | 62.0% |

As shown in Table 2, for estimate for income at the time of retirement of $65,000, the base replacement rate is 90%.

In some embodiments, the expense calibration rate (Cᵣₐₜₑ) can be determined as follows:

Cᵣₐₜₑ=Eₑₓₚ+Dₑₓₚ+Hₑₓₚ EQN. 4

where Eₑₓₚ is an essential expense rate, Dₑₓₚ is a discretionary expense rate and Hₑₓₚ is a healthcare expense rate.

In some embodiments, the essential expense rate (Eₑₓₚ), the discretionary expense rate (Dₑₓₚ) and the healthcare expense rate (Hₑₓₚ) are input by a user.

In some embodiments, the essential expense rate (Eₑₓₚ) is based on a credit score of the individual. While certain kind of expenses like housing, food and/or transportation can be classified as essential expenses, individuals can have their own preferences and budgets for each category. Credit scores can be helpful to assess financial discipline of individuals. People with higher debt-to-income and lower credit scores can be more likely to live paycheck-to-paycheck. Households with higher leverage can be more likely to save less and describe a higher proportion of their spending as essential expenses. Essential expenses can be calibrated according to the credit score of the individual. In various embodiments, the user inputs one, two or three credits scores. In some embodiments, the credit scores are received from the three major credit reporting agencies. In these embodiments, an individual can give permission to interface with the credit reporting agencies. In some embodiments, an average of the credit scores is determined. Table 3 shown below is an example of essential expense rates (Eₑₓₚ) for various credit scores.

TABLE 3

| Credit Score | Essential Expense Rates |
|---|---|
| <600 | 60% |
| 600-650 | 59% |
| 650-700 | 58% |
| 700-750 | 56% |
| 750-800 | 53% |
| <800 | 50% |

As shown in Table 3, for a credit score of 700, the essential expense rate (Eₑₓₚ) is 56%.

In some embodiments, the discretionary expense rate (Dₑₓₚ) is based on lifestyle of the individual. Retirement for certain individuals may no longer be synonymous with shuffleboard and early bird suppers. A growing number of retirees are planning to maximize travel, adventures, and/or new activities. Current lifestyle can have a high correlation with lifestyle in retirement. Discretionary spending in retirement can be predicted based on current discretionary spending and/or activity levels of an individual. Discretionary spending can include travel, entertainment (e.g., theatre/restaurant spending) and/or gifting (e.g., to children). The discretionary expense rate (Dₑₓₚ) can be determined based on a lifestyle of an individual. The lifestyle of the individual can be input by a user. Table 4 shown below is an example of discretionary expense rates (Dₑₓₚ) for various lifestyles.

TABLE 4

| Lifestyle | Discretionary Expense Rate |
|---|---|
| Very Active | 25% |
| Active | 20% |
| Less Active | 15% |
| Min Active | 10% |

As shown in Table 4, for a lifestyle of Active, the discretionary expense rate is 20%.

In some embodiments, the healthcare expense rate (Hₑₓₚ) is based on an expected health of the individual upon retirement. In some embodiments, with the individual's consent and participation, the individual can allow consideration of key factors related to health and wellness when retirement planning. An individual can include consideration of their health history and current health condition to adjust baseline variables supported by range of numbers. The retirement expenses can tick downwards for certain health concerns (e.g., over weight, smoking, medical issues, etc.) and tick upwards for healthy habits (e.g., regular exercise, healthy weight, non-smoker, proper diet, etc.). In some embodiments, in addition and in conjunction with certain health care insurance providers, the variable values can be pulled from the providers with the customers consent to set the baseline variables. Table 5 show below is an example of healthcare expense rates (Hₑₓₚ) for various health levels and various death ages (i.e., plan ages). In some embodiments, health is input by a user.

TABLE 5

| Health | Healthcare Expense Rate | Plan Age |
|---|---|---|
| Excellent | 10% | 95 |
| Good | 15% | 92 |
| Average | 20% | 92 |
| Poor | 30% | 85 |
| Not Sure | 20% | 92 |

As shown in Table 5, for a health of Poor, the healthcare expense rate is 30%.

The goal calibration module 220 determines the amount of retirement spending as follows:

R_{spend}=Rᵣₐₜₑ×Iₑₛₜ EQN. 5

where R_{spend} is the amount of retirement spending, Rᵣₐₜₑ is the retirement income replacement rate, and Iₑₛₜ_{_{—}}ᵣₑₜ is the estimated income at retirement.

An example of the outcome of the goal calibration module 220 for a hypothetical individual, Individual 1, is as follows:

Assume Individual 1, is 25 year olds with $40,000 annual earning and planning to retire at age 67. Individual 1 has a credit score of 760, a “Very Active” lifestyle, and is in “Good” health.

Assuming a real wage growth rate of 1.5% per annum, using EQN. 2 shown above, estimated income at retirement (Iₑₛₜ_{_{—}}ᵣₑₜ) is approximately $73,650. Using Table 2 shown above, the base replacement rate for Iₑₛₜ_{_{—}}ᵣₑₜ of $73,650 is 85%.

Using Table 3 shown above, for Individual 1 having a credit score of 760, the essential expense rate (Eᵣₐₜₑ) for Individual 1 is 53%. Using Table 4 shown above, for Individual 1 having a lifestyle of “Very Active” for lifestyle, the discretionary expense rate (Dᵣₐₜₑ) for Individual 1 is 25%. Using Table 5 shown above, for Individual 1 having a health of “Good” the healthcare expense rate (Hᵣₐₜₑ) for Individual 1 is 15%.

Using EQN. 4 shown above, the expense calibration rate (Cᵣₐₑ) for Individual 1 is 53%+25%+15%=93%.

Using EQN. 3 shown above, the replacement rate (Rᵣₐₜₑ) for Individual 1 is 85%+93%=79%. Using EQN. 5 shown above, the amount of retirement spending per year (R_{spend}) for the individual is $73,650×79%=$58,220

ii. Retirement Simulation Module

The retirement simulation module 240 determines a retirement planning horizon, a retirement preparedness score, a suggested risk profile for investing, and/or other actions/recommendations for planning for retirement. The retirement simulation module 240 takes as input the amount of retirement spending (R_{spend}) determined by the goal calibration module 220, a confidence level (CL) from the risk calibration module (discussed in further detail below), household demographic information, income, assets, contributions to retirement and/or non-retirement financial goals as input. The retirement simulation module 240 can perform Monte Carlo simulations based on the inputs to determine. One hundred, one thousand, or ten thousand simulations can be performed during a single Monte Carlo analysis. As is apparent to one of ordinary skill in the art, any number of simulations can be performed for a Monte Carlo analysis. The Monte Carlo analysis can be performed based on market assumptions regarding the average returns and market volatility.

For a given individual, a plurality of simulations can be performed. A retirement planning horizon can be input by the user. The retirement planning horizon is the year of retirement. A retirement preparedness score can be determined based on the expected income from savings, which can be different for each simulation, divided by required income (e.g., R_{spend} as shown above). The risk profile is the suggested asset mix for an investor and can be presented to the user. The risk profile can be based on outputs of the goal calibration module 220 and the risk calibration module 230. The risk profile can be determined based on any method known in the art.

A single scenario based on the confidence level (CL) can be selected to present to the user.

iii. Risk Calibration Module

The risk calibration module 230 determines a confidence level (CL) for the retirement plan. The risk calibration module 230 can determine the confidence level (CL) based on a credit score percentile base (CS %) and a savings score percentile add-on (SS %). The confidence level (CL) can be determined as follows:

CL=100−(CS %+SS %) EQN.5

In some embodiments, the credits score percentile base (CS %) is based on the credit score of the individual. Table 6 is an example of the credit score percentile base (CS %) for various credit scores.

TABLE 6

| Credit Score | Monte Carlo Percentile - Base |
|---|---|
| <=600 | 5% |
| 601-650 | 7% |
| 651-700 | 9% |
| 701-750 | 11% |
| 751-800 | 13% |
| >800 | 15% |

As shown in Table 6, for a credit score of 651, the credit score percentile base (CS %) is 9%.

In some embodiments, the credit score is input by the user. In some embodiments, the credit score is the average of three credit scores obtained from the three major credit reporting agencies.

In some embodiments, the savings score percentile add-on (SS %) is based on a savings score of the individual. Table 7, shown below, is an example of the saving score percentile add-on (SS %) for various savings scores.

TABLE 7

| Savings Score | Monte Carlo Percentile - Addon |
|---|---|
| 0-20 | 2% |
| 21-40 | 4% |
| 41-60 | 6% |
| 61-80 | 8% |
| 81-100 | 10% |

As shown in Table 7, for a savings score of 42, the savings score percentile add-on (SS %) is 6%.

The savings score (SS) can be determined as follows:

SS=SRS+SRDS+SHS EQN. 6

where SRS is the savings rate score, SRDS is the savings rate direction score, and SHS is the savings history score.

In some embodiments, the savings rate score (SRS) is input by the user. In some embodiments, the savings rate score (SRS) is based on a number of years the individual has until retirement (e.g., horizon) and savings rate. The savings rate can be determined by dividing the contributions to savings by the individual over the past year by income of the individual. Table 8, shown below, is an example of savings rate scores (SRS) for various savings rates and various years to retirement.

TABLE 8

Horizon

| | 0-5 | 5-10 | 10-15 | 15-20 | 20 or more |
|---|---|---|---|---|---|
| Rate | years | years | years | years | years |
| 0%-5% | 0 | 5 | 10 | 15 | 20 |
| 5%-10% | 10 | 15 | 20 | 25 | 30 |
| 10%-15% | 20 | 25 | 30 | 35 | 40 |
| 15%-20% | 25 | 35 | 40 | 45 | 50 |
| 20% or more | 30 | 40 | 50 | 55 | 60 |

As shown in Table 8, for a savings rate of 10% and 5 years to retirement, the savings rate score (SRS) is 25.

In some embodiments, the savings rate direction score (SRDS) is input by the user. In some embodiments, the savings rate direction score (SRDS) is based determining a saving direction for the individual. The savings direction can be determined over a predetermined number of years. In some embodiments, the predetermined number of years is one, two, three, or any number of years. In some embodiments, the savings direction can be determined by performing a linear regression fit of savings rates of the individual over the past three years.

A savings rate for a first year of the last three years, a second year of the last three years and a third year of the last three years can be determined. The savings rate is determined by dividing the saving for the year by income for the year.

The linear regression can be determined based on the savings rate for the first year, the second year and the third year of the last three years. If the linear regression fit is positive, then the savings direction is increasing. If the linear regression fit is flat, savings direction is stable. If the linear regression fit is negative, then the savings direction is decreasing. Table 9, shown below, is an example of the savings rate direction scores (SRDS) for various savings direction.

TABLE 9

| Direction over last 3 years | Sub-Score |
|---|---|
| Decreasing | 0 |
| Stable | 20 |
| Increasing | 30 |

As shown above in Table 9, for a savings direction of stable, a savings rate direction score (SRDS) is 20.

In some embodiments, the savings rate history score (SRHS) is input by a user. In some embodiments, the savings rate history score is based on a number of continuous years the individual has saved. Table 10, shown below, is an example of the saving rate history score (SRHS) for various durations of continuous savings.

TABLE 10

| No. of Continuous Years | Sub-Score |
|---|---|
| 0-2 | 0 |
| 2-5 | 5 |
| >5 | 10 |

As shown above in Table 10, for an individual who has continuously saved over the past 3 years, the savings rate history score (SRHS) is 10.

An example of the outcome of the risk calibration module 230 is as follows:

Assume an individual that is the same individual in the example above, Individual 1, with 42 years to retirement and an income history and savings history as follows in Table 11.

TABLE 11

| Income History | | | Savings History | | | |
|---|---|---|---|---|---|---|
| Income 2 | Income | Income | Savings 2 | Savings | Savings | Positive |
| Years Ago | Previous | This Year | Years Ago | Previous | This Year | Savings |
| (2011) | Year (2012) | (2013) | (2011) | Year (2012) | (2013) | since |
| $36,000 | $38,000 | $40,000 | $3,000 | $4,000 | $4,000 | 2007 |

Using Table 8 above, for Individual 1, with 42 years left until retirement and a savings rate of 10% (i.e., $4,000/$40,000), the savings rate score (SRS) is 40.

The savings rate for the first year of the last three years for Individual 1 is 10% (i.e., $4,000/$40,000), the savings rate for the second year of the last three years for Individual 1 is 10.8% (i.e., $4,000/$38,000), and savings rate for the third year of the last three years for Individual 1 is 8.3% (i.e., $3,000/$36,000). The linear regression fit of 10%, 10.5% and 8.3% in the last three years is positive at 0.83. Using Table 9 above, a positive linear regression fit results in a savings rate direction score (SRDS) of 30.

Using Table 10 above, for Individual 1, having a positive savings for six years (i.e., positive savings since 2007), the savings history score (SHS) is 10.

For Individual 1 having a savings rates score (SRS) of 40, a savings rate direction score (SRDS) of 30, and a savings history score (SHS) of 10, the savings score (SS) is 80 (i.e., 40+40+10).

For a savings score of 80, using Table 7 above, Individual 1 has a savings score percentile add-on of 8%. Individual 1 has a credit score of 760. Using Table 6, Individual 1 has a credit score percentile base of 13%. The overall confidence level for Individual 1 is 79% (i.e., 100%−(8%+13%)).

The confidence level (CL) can be input to the retirement simulation module 240, such that when the retirement simulation module runs a Monte Carlo simulation, a scenario corresponding to the confidence level can be selected. Assume for example, that for Individual I the retirement simulation module 240 performs a Monte Carlo simulation having 10,000 market scenarios. The results can be sorted in increasing order of success against the income goal. Instead of presenting a range of these outcomes to a user, a single scenario, at 21% percentile or 79% confidence level (100%-21%=79%; or percentile+confidence-level=100%) can be selected for the output to the user. In this example, the 2100^{th} scenario in this ascending sorted list of scenarios is chosen as the final presentation to the user.

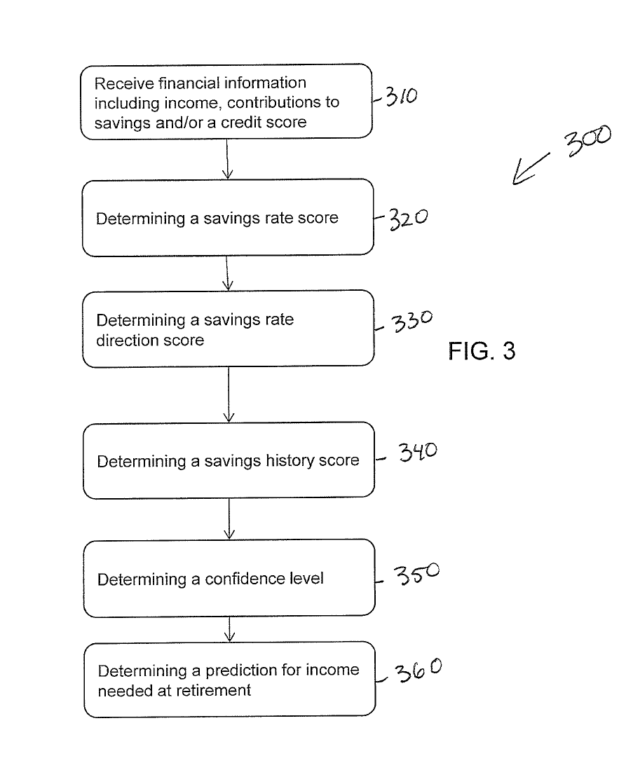

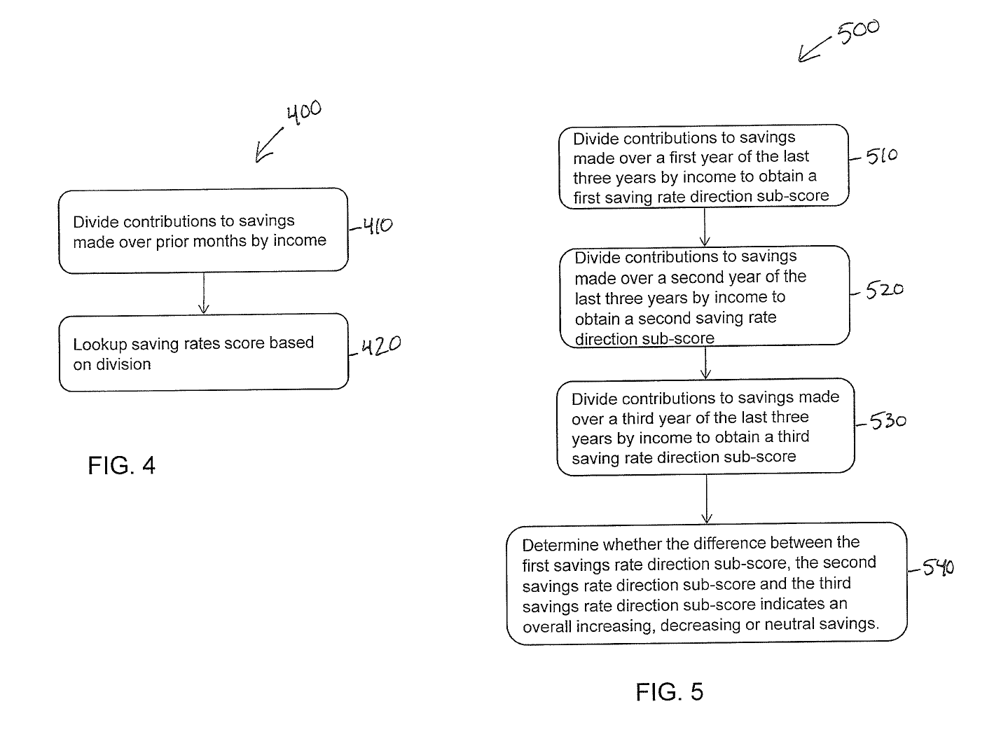

FIG. 3. FIG. 4 and FIG. 5, are flow diagrams showing a method for retirement planning, according to illustrative implementations of the personalized retirement tool.

FIG. 3 is a flow diagram showing a method 300 for retirement planning, according to an illustrative implementation of the personalized retirement tool. The method 300 includes receiving, by a computing device, financial information including income, contributions to savings, and/or a credit score of an individual, as for example, described above with respect to FIG. 2 (Step 310).

The method 300 also involves determining a savings rate score (Step 320) (e.g., the savings rate score (SRS) as described above with respect to FIG. 2). The savings rate score (SRS) can be determined as shown in FIG. 4.

FIG. 4 is a flow diagram showing a method 400 for determining a savings rate score, according to an illustrative implementation of the personalized retirement tool. The method 400 involves dividing contributions to savings made by the individual over prior months (e.g., 12 months) by the income of the individual (Step 410). The method 400 also involves using a look up table to determine a savings rate score (SRS) based on the outcome of Step 410 and a number of years to retirement for the individual (Step 420) (e.g., the SRS lookup table shown above in Table 8).

The method 300 also involves determining a savings rate direction score (SRDS) (Step 230). The savings rate direction score (SRDS) can be determined as shown in FIG. 5.

FIG. 5 is a flow diagram showing a method 500 for determining a savings rate direction score (SRDS), according to an illustrative implementation of the personalized retirement tool. The method 500 involves dividing contributions to savings made by the individual over a first year of the last three years by the income to obtain a first saving rate sub-score (Step 510). The method 500 also involves dividing contributions to savings made by the individual over a second year of the last three years by income to obtain a second saving rate sub-score (Step 520). The method 500 also involves dividing contributions to savings made by the individual over a third year of the last three years by income to obtain a third saving rate sub-score (Step 530). The method 500 also involves determining whether the difference between the first savings rate sub-score, the second savings rate sub-score, and the third savings rate sub-score indicate an increasing, decreasing or neutral savings (Step 540).

The method 300 also involves determining a savings history score (SHS) (Step 240). The savings history score (SHS) can be determined as shown above in FIG. 2. The method 300 also involves, determining a confidence level (Step 250) (e.g., as shown above in FIG. 2). The method 300 also involves, determining a prediction for income needed at retirement (Step 260) (e.g., as shown above in FIG. 2).

The above-described systems and methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM. EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, tablet) with a world wide web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A computerized method of retirement planning, the method comprising:
receiving, by a computing device, financial information for an individual, the financial information including income, contributions to savings over a time duration, and a credit score;
determining, by the computing device, a savings rate score for the individual, the savings rate score based on the income, contributions to savings made by the individual over one prior year, and a number of years until the individual retires;
determining, by the computing device, a savings rate direction score for the individual, the savings rate direction score based on the income and contributions to savings made by the individual over a selected prior years;
determining, by the computing device, a confidence level based on the savings rate score, the savings rate direction score, the savings history score and the credit score;
determining, by the computing device, a prediction for income required at retirement for the individual, wherein the prediction is based on a rate for income replacement, the rate for income replacement based on essential expenses, discretionary expenses, healthcare expenses, or any combination thereof; and
determining, by the computing device, a retirement preparedness score for the individual based on expected income from savings divided by the predicted income required at retirement for the individual, the expected income from savings having the determined confidence level.

2. The method of claim 1, further comprising receiving, by the computing device, health information, lifestyle information, or any combination thereof.

3. The method of claim 1 wherein determining the savings rate score further comprises:
dividing, by the computing device, the contributions to savings made by the individual over twelve prior months by the income;
receiving, by the computing device, the savings rate score based on a table look-up that receives as input results of the division.

4. The method of claim 1 wherein determining the savings rate direction score further comprises:
dividing, by the computing device, the contributions to savings made by the individual over a first year of the three prior years by the income to obtain a first savings rate direction sub-score;
dividing, by the computing device, the contributions to savings made by the individual over a second year of the three prior years by the income to obtain second savings rate direction sub-score;
dividing, by the computing device, the contributions to savings made by the individual over a third year of the three prior years by the income to obtain a third savings rate direction sub-score;
determining, by the computing device, whether the difference between the first savings rate direction sub-score, the second savings rate direction sub-score and the third savings rate sub-score indicates an overall increasing, decreasing or neutral savings rate direction for the individual; and
receiving, by the computing device, the savings rate direction score based on a table look-up that receives as input the savings rate direction for the individual.

5. The method of claim 1 wherein determining the savings history score for the individual further comprises receiving, by the computing device, the savings history score based on a table look-up that receives as input the time duration.

6. The method of claim 1 wherein determining the confidence level further comprises adding, by the computing device, the savings rate score, the savings rate direction score, the savings history score and the credit score.

7. The method of claim 1 wherein determining the prediction for income needed at retirement for the individual further comprises:
receiving, by the computing device, a first set of information, the first set of information including demographic information, asset information, retirement-goal information, non-retirement goal information, or any combination thereof;
performing, by the computing device, Monte Carlo simulation based on the first set of information; and
selecting, by the computing device, a result of the Monte Carlo simulation having the confidence level.

8. The method of claim 7 further comprising:
receiving, by the computing device, a second set of information, the second set of information healthcare information, lifestyle information, or any combination thereof; and
determining, by the computing device, a planning horizon based on the second set of information, wherein the Monte Carlo simulation is further based on the planning horizon.

9. The method of claim 1 wherein determining the prediction for income further comprises:
receiving, by the computing device, credit information, lifestyle information and healthcare information;
determining, by the computing device, essential expenses, the essential expenses based on the credit information;
determining, by the computing device, discretionary expenses, the discretionary expenses based on the lifestyle information; and
determining, by the computing device, healthcare expenses based on the healthcare information.

10. The method of claim 9 wherein the credit information is received from one or more credit reporting bureau.

11. The method of claim 9 wherein the lifestyle information is received from one or more social media websites.

12. The method of claim 9 wherein the lifestyle information includes places the individual has checked in in from, stores the individual has purchased items from, pages the individual has viewed, social media gifting, or any combination thereof.

13. The method of claim 9 wherein the healthcare information is received from one or more healthcare providers.

14. The method of claim 13 wherein the healthcare information includes projected costs for treating health conditions of the individual.
